(19) United States
(12) Patent Application Publication
(10) Pub. No.: US 2019/0076696 A1
(43) Pub. Date: Mar. 14, 2019

(54) IMPROVEMENTS IN OR RELATING TO EXERCISERS

(71) Applicant: Charles Thomas Fitzjames Townsend, Surrey (GB)

(72) Inventor: Charles Thomas Fitzjames Townsend, Surrey (GB)

(21) Appl. No.: 16/083,490

(22) PCT Filed: Mar. 9, 2017
(86) PCT No.: PCT/GB2017/050630

§ 371 Date: Sep. 7, 2018

(30) Foreign Application Priority Data
Mar. 9, 2016 (GB) 1604023.0

(51) Int. Cl. A63B 23/08

(52) U.S. Cl. CPC A63B 23/085; A61H 1/0266

(57) ABSTRACT

According to the invention, there is provided an exerciser suitable for exercising lower leg muscles wherein the exerciser comprises a support and a two part foot platform wherein each part of the foot platform is rotatable such that a first part of the foot platform allows plantar flexion rotational movement of a foot and that a second part of the foot platform allows dorsiflexion rotational movement of the foot; and a dual foot exerciser wherein the respective first parts of each foot platform are connected together and/or the respective second parts of each foot platform are connected together such that movement of a first or second part on one exerciser moves the corresponding first or second part of the other exerciser; by separating the movement of the foot by the provision of a two part rotatable foot platform, the exerciser allows natural movement of the foot, ankle and lower leg; with the optional addition of a resilient member of variable resistance for muscle strengthening and/or a mechanical device to move each of the foot-plates individually or in sequence, to provide plantar and dorsi flexion where voluntary movement is affected such as in MS or foot drop from stroke.

The present invention provides an exercise suitable for use by a wheelchair user and others with impaired muscle tone and/or blood and fluid circulation.

The problem for the elderly, especially those using wheelchairs is lack of exercise and activity. Existing devices can be cumbersome, or require setting up: where the wheelchair user will need to have the wheelchair attached to the exercise device. This requires a will to exercise and extra time for the user as well as the carer. Also, the elderly in general (those in care homes in particular) tend to sit for long periods without much movement of the lower limbs; the resulting deterioration of muscles and competency of blood vessels causes health problems. The current guidelines state that they should get up and move every 20 minutes. This is impractical in care homes and for wheelchair users.

Similar problems are occurring in the office situation with younger people who are sitting at a computer for hours without getting up and moving the lower limbs. Research is showing that the effects of sitting still for long periods cannot be negated with a 45 minute session in the gym at the end of the day.

A way of ameliorating these problems has been sought.

According to the invention there is provided an exerciser suitable for exercising lower leg muscles wherein the exerciser comprises a support and a two part foot platform wherein each part of the foot platform is rotatable such that one part of the foot platform allows plantar flexion rotational movement of a foot and that another part of the foot platform allows dorsiflexion rotational movement of the foot.

Advantages of the invention include that by separating the movement of the foot by the provision of a two part rotatable foot platform, the exerciser allows natural movement of the foot, ankle and lower leg. By separating out plantar flexion movement, the gastrocnemius muscle can be developed which is helpful for wheelchair bound or elderly people. This is because the action of this muscle is to create a ‘calf pump’ which improves blood circulation by aiding venous return. As well as movement of the foot, there will also be movement in the knee joint with plantar flexion, providing ‘low impact’ exercise of this joint. By working separately on dorsiflexion movement, the anterior tibialis muscle may be developed. This muscle is involved in balance and gait and so by working on it, stability and confidence may be improved. As dorsiflexion movement is plantar flexion movement in reverse, the ‘calf pump’ is also developed to aid circulation. Furthermore, the exerciser according to the invention improves the range of ankle movement.

It should be understood that herein dorsiflexion and plantar-flexion are terms used to define ankle movement. The term “dorsum” refers to an upper surface of a foot and the term “plantar” refers to the sole of a foot. The term “dorsiflexion” refers to a flexion movement of an ankle such that the foot rotates upwards or superiorly. The term “plantar-flexion” refers to an extension movement of an ankle such that the foot rotates downwards or inferiorly. The magnitude of either movement relates to the range of ankle movement (also known by the abbreviation “ROAM”).

Further advantages of the invention include potential health benefits such as:
Muscular/skeletal benefits by improving the range of movement and mobility of joints;
Strengthening of muscles;
Neurological benefits: it can help prevent stiffness and muscle wasting for peripheral neuropathy and for central neuropathy in stroke patients;
Vascular benefits: by aiding venous return, by helping move blood and reduce pressure in the lower limbs; which otherwise can lead to ulceration and blood stagnation;
Arterial benefits: by aiding collateral circulation and reducing peripheral vascular disease;
Lymph benefits; lymph fluid only moves through muscular movement and its return will be aided by the exercise;
Reduction in risk of oedema;
Thrombosis can be averted through the regular use of the units;
Psychological: enabling patients to do something achievable and the social aspect of participating in a group for those with limited ability/mobility;
Convalescence and habituation from long term injuries by at least reducing loss of tone and of muscle mass through regular use. This device addresses the problem in hospital with an elderly patient who has completed their surgery but is then unable to be discharged because of deterioration in the lower limbs and loss of mobility, and possibly acquiring new illnesses as a result of inactivity;
Reducing the incidence of falls by strengthening the leg muscles of an infirm or elderly person, patient or care home resident;
Foot ulcers can be addressed where the patient cannot bear weight on their feet. With the invention, they can move and exercise the lower limbs (possibly with the addition of special dressings or foot pads) without the need to weight bear; and
Patients requiring long term bed rest can exercise in bed using the device.

Additional advantages include that the exerciser does not look like exercise equipment and is less cumbersome or bulky than existing equipment. Indeed the exerciser according to the invention promotes movement of the user's lower limbs rather than exercise.

In some embodiments, the exerciser is formed from a sterilisable plastic material such that it may be re-used in a hospital, care home, nursing home or other location.

In some embodiments, the exerciser is portable. A portable exerciser may have the advantages that it is of a size and simplicity to enable frequent use without the need for a carer to be present to wheel the user into a room and fix the device into position and then after exercise to remove. Saving time and money and also putting the emphasis on the user to do the exercise/movements.

In some embodiments, the exerciser may have a connector for a wheelchair. By having a wheelchair connector, the exerciser could be used to replace the footplate of a wheelchair such that it is available continually for a user.

In some embodiments, the exerciser may be in the form of a foot rest. A foot rest exerciser would be useful for a person sitting for long periods in a chair such as an office worker or a traveller on a coach or aeroplane. Accordingly, the long periods could be punctuated with the person using the exerciser; where the exerciser remains as a foot rest when not used.

In some embodiments, the exerciser may comprise a base. The base may comprise the connector for a wheelchair. In some embodiments, the base may have one or more formations for engaging the support.

In some embodiments, the base may comprise a lower fixing plate and an upper fixing plate which are connectable to allow the base to be attached to a frame or to furniture such as a chair or a bed.

In some embodiments, the support may comprise two support walls. In some embodiments, the support may form a stop to prevent over-rotation of one part of the two part foot platform. For example, the support stop may be a curved end and/or an inner wall. By preventing over-rotation of one part of the two part foot platform, the support stop allows separate plantar flexion and dorsiflexion rotational movement of a foot. In some embodiments, each part of the foot platform is separately rotatable.

In some embodiments, the two-part foot platform comprises a first lower platform and a second upper platform. In some embodiments, the first platform may have an indentation shaped to receive the second platform. Advantages of the indentation include that it may act as a stop to prevent over-rotation of the second platform. In some embodiments, the indentation may have an opening to allow the second platform to be rotated relative to the first platform. In some embodiments, the first platform may be shaped to engage with a support stop. In some embodiments, the first platform may be connected to the support by a first platform hinge such that the first platform may be rotated relative to the support. In some embodiments, the first platform hinge allows plantar flexion rotational movement of a foot. In some embodiments, the first platform hinge comprises a resilient member to provide resistance to the rotation of first platform hinge. The advantages of a resilient member include that it allows a user to develop lower leg strength, which is useful for those rehabilitating from illness or injury.

In some embodiments, the second upper platform may be shaped to support a foot. In some embodiments, the second platform may have a plurality of formations to help secure a foot. In some embodiments, the second platform may have a toe cap to help ensure correct positioning of a foot on the second platform. In some embodiments, the second platform may have a heel cup to help ensure the correct positioning of a foot on the second platform. In some embodiments, the heel cup may be moveable so that different lengths of foot may be supported. In some embodiments, the second platform may include a strap for securing a foot to the platform. In some embodiments, the second platform may be connected to the first platform by a second platform hinge. In some embodiments, the second platform hinge allows dorsiflexion rotational movement of a foot. In some embodiments, the exerciser includes a resilient member for providing resistance to the movement of one or both platforms, for example the second platform hinge comprises a resilient member to provide resistance to the rotation of the second platform hinge. In some embodiments, the exerciser includes a resilient member resistance mechanism for controlling the degree of resistance provided by the resilient member. In some embodiments, the resilient member may be a leaf or coil spring or an air bladder.

In some embodiments, the exerciser includes a motor mechanism which is connected to the first and/or second parts of the foot platform so as to assist movement of the foot platform. In some embodiments, the motor mechanism is positioned to apply force to a middle of each platform. In some embodiments, the motor mechanism includes a linkage such as a crank or a cam, optionally the linkage is replaceable such that the degree of movement of the foot platform may be varied. In some embodiments, the exerciser includes a control panel for controlling the speed of rotation of the motor mechanism. In some embodiments, the exerciser includes a power source in the form of a battery.

According to the invention, there is also provided a dual foot exerciser which comprises two exercisers according to the invention wherein the respective first parts of each foot platform are connected together and/or the respective second parts of each foot platform are connected together such that movement of a first or second part on one exerciser moves the corresponding first or second part of the other exerciser. The advantage of having a dual foot exerciser with one or both axles being in common is that where a patient has a particular muscle weakness in one leg, the other, healthier leg can assist the movement of the weaker leg because the common axle means that when one part of the two part foot platform is moved on one exerciser, the corresponding part of the two part foot platform is moved on the other exerciser. In this way, a healthier leg can provide a weaker leg with proprioceptive feedback to help a patient to relearn how to use a muscle, for example for a stroke patient.

In some embodiments, the first platform and/or second platform may include a monitoring device to detect movement. In some embodiments, a suitable monitoring device may be an accelerometer.

The invention will now be illustrated with reference to the following Figures of the accompanying drawings which are not intended to limit the scope of the claims:

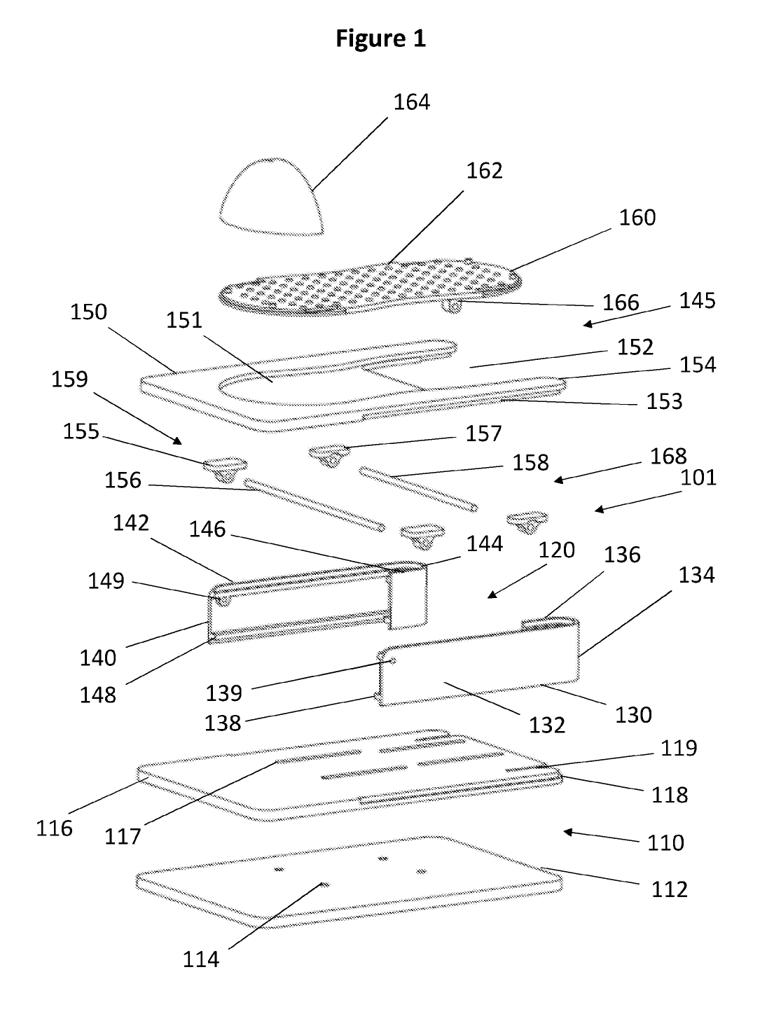

FIG. 1 shows a schematic exploded view of a first embodiment of the exerciser according to the invention;

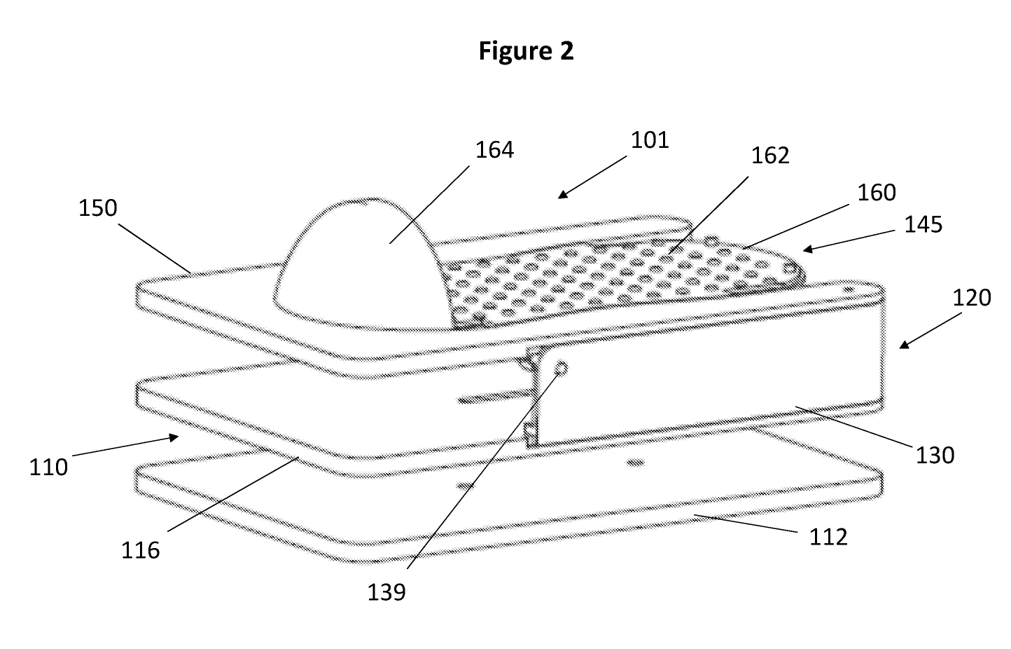

FIG. 2 shows a schematic perspective view of the first embodiment of the exerciser according to the invention;

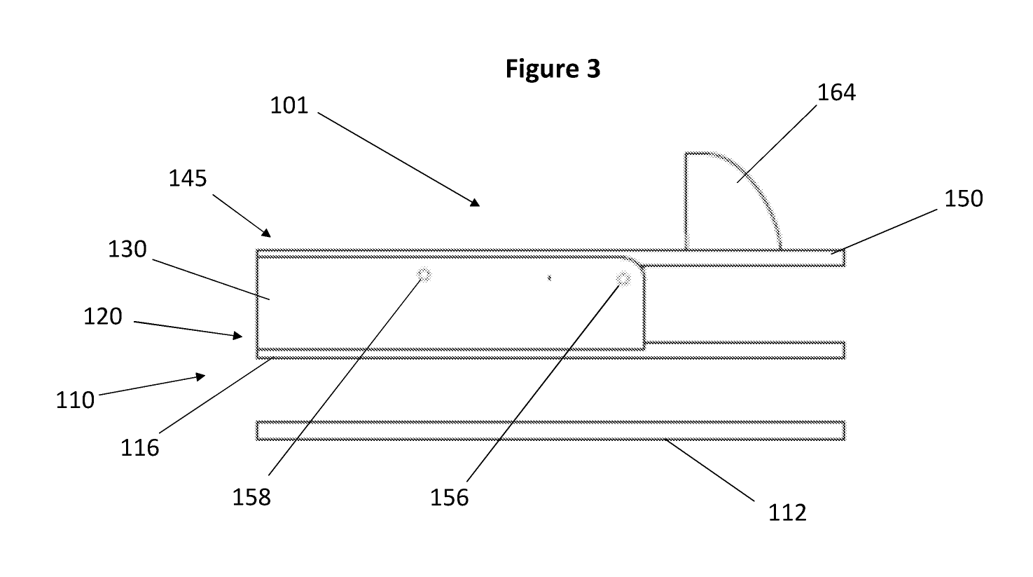

FIG. 3 shows a schematic side view of the first embodiment of the exerciser according to the invention;

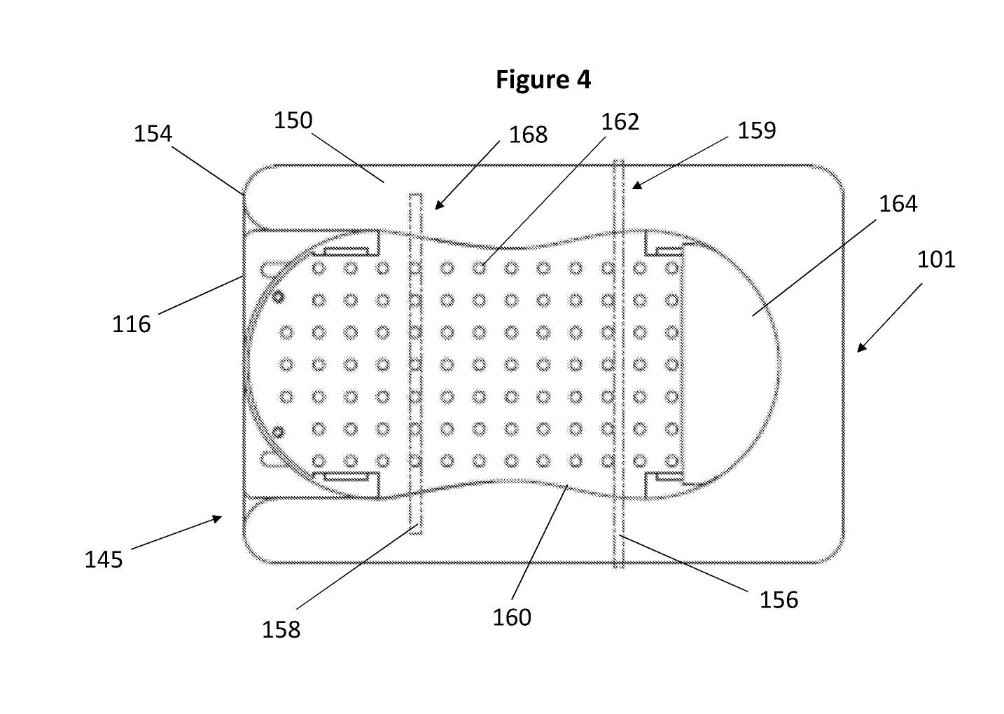

FIG. 4 shows a schematic overhead view of the first embodiment of the exerciser according to the invention;

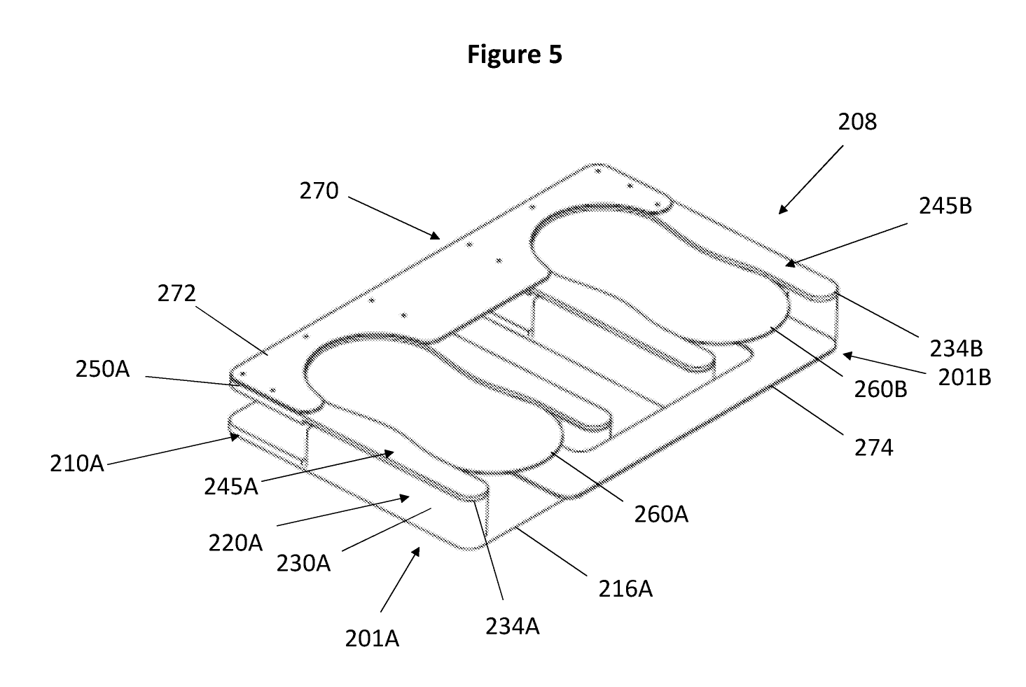

FIG. 5 shows a first schematic perspective view of a second embodiment of the exerciser according to the invention in its resting position;

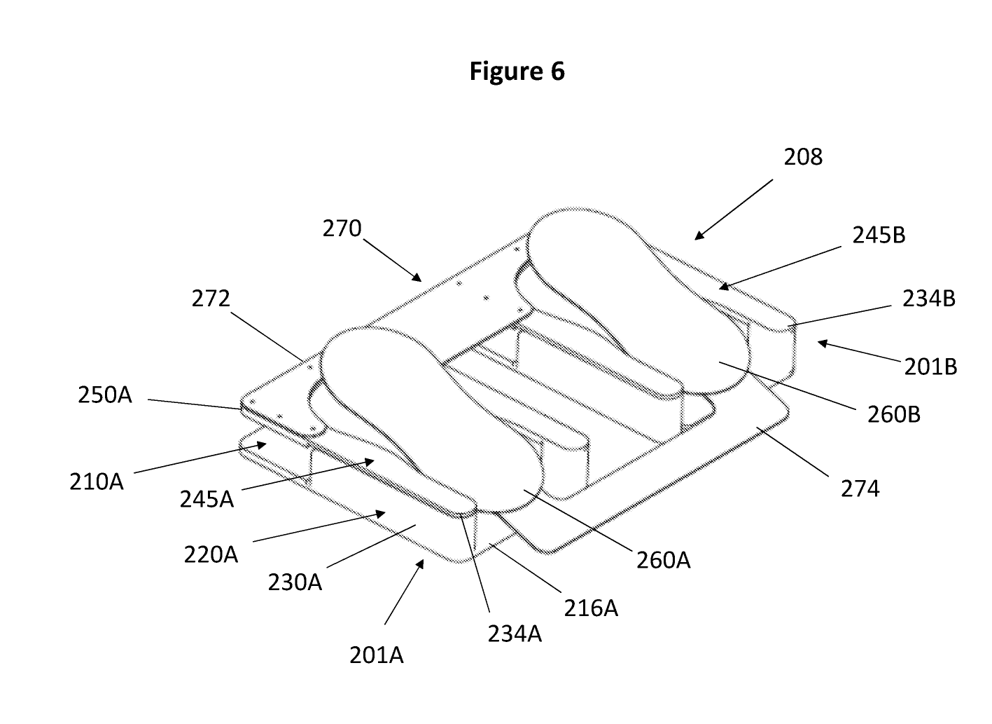

FIG. 6 shows a second schematic perspective view of the second embodiment of the exerciser according to the invention in a position after a dorsiflexion movement;

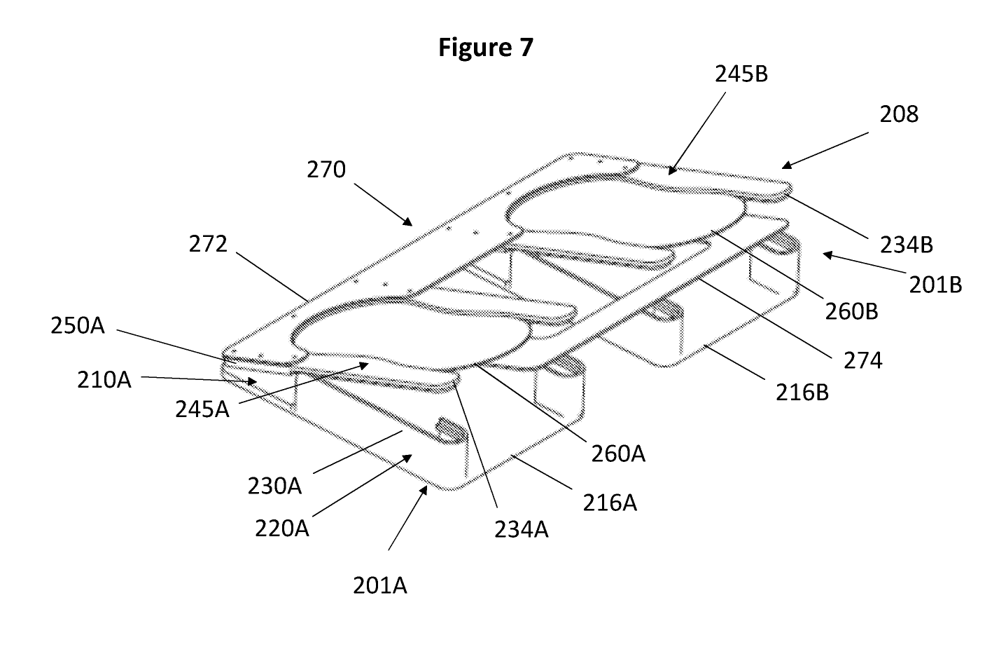

FIG. 7 shows a third schematic perspective view of the second embodiment of the exerciser according to the invention in a position after a plantarflexion movement;

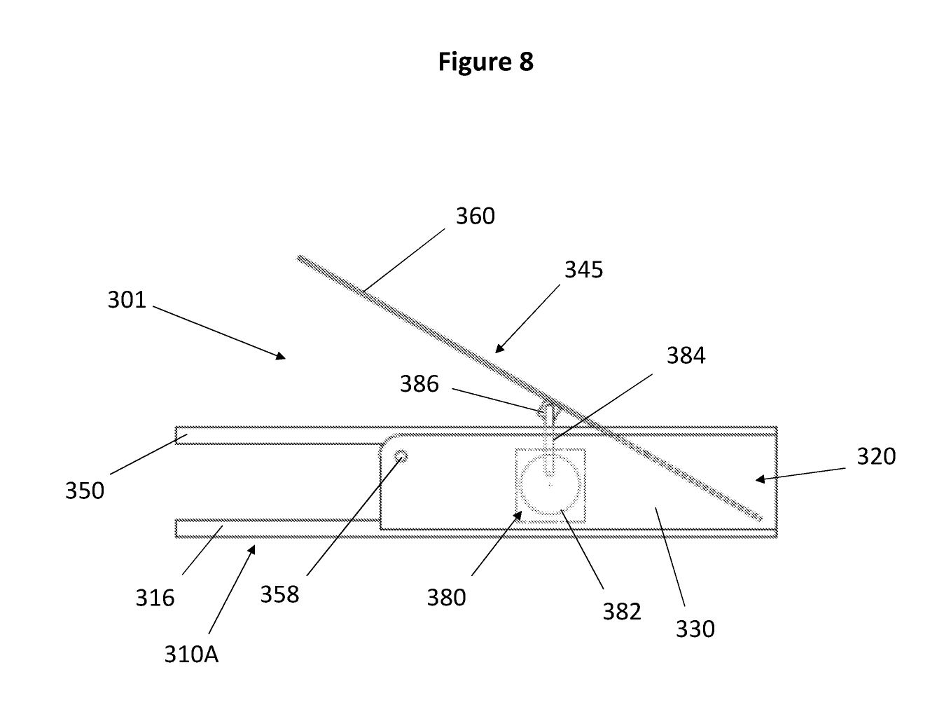

FIG. 8 shows schematic side view of a third embodiment of the exerciser according to the invention in a second position after a plantar flexion movement;

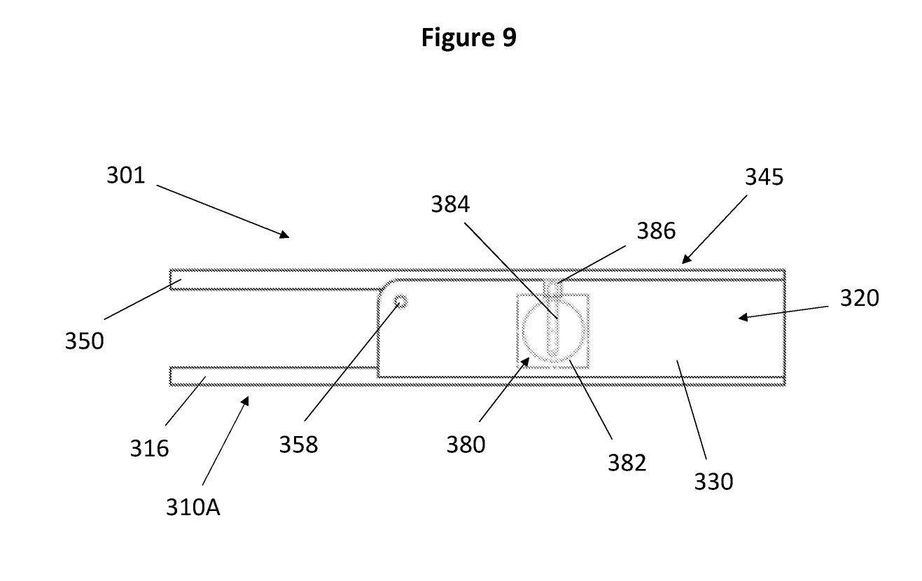

FIG. 9 shows a schematic side view of a third embodiment of the exerciser according to the invention in a first position;

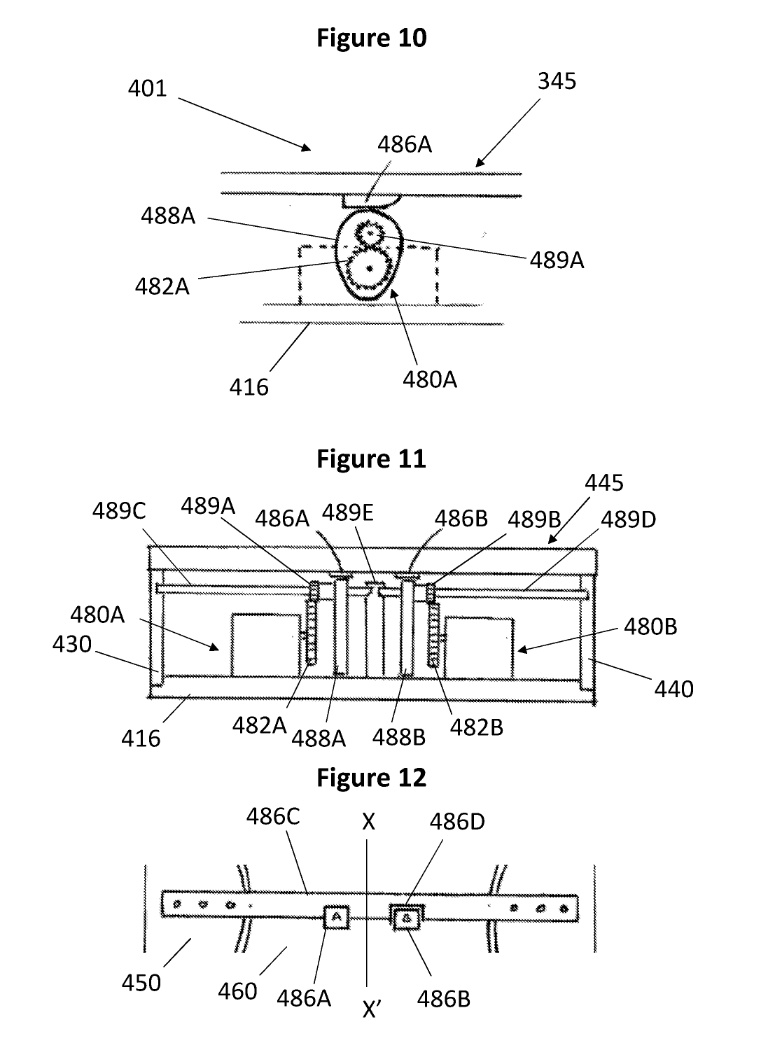

FIG. 10 shows a schematic partial side view of a fourth embodiment of the exerciser according to the invention in a first position;

FIG. 11 shows a schematic end view of the fourth embodiment of the exerciser according to the invention in a first position;

FIG. 12 shows a schematic partial plan view of the fourth embodiment of the exerciser according to the invention in a first position;

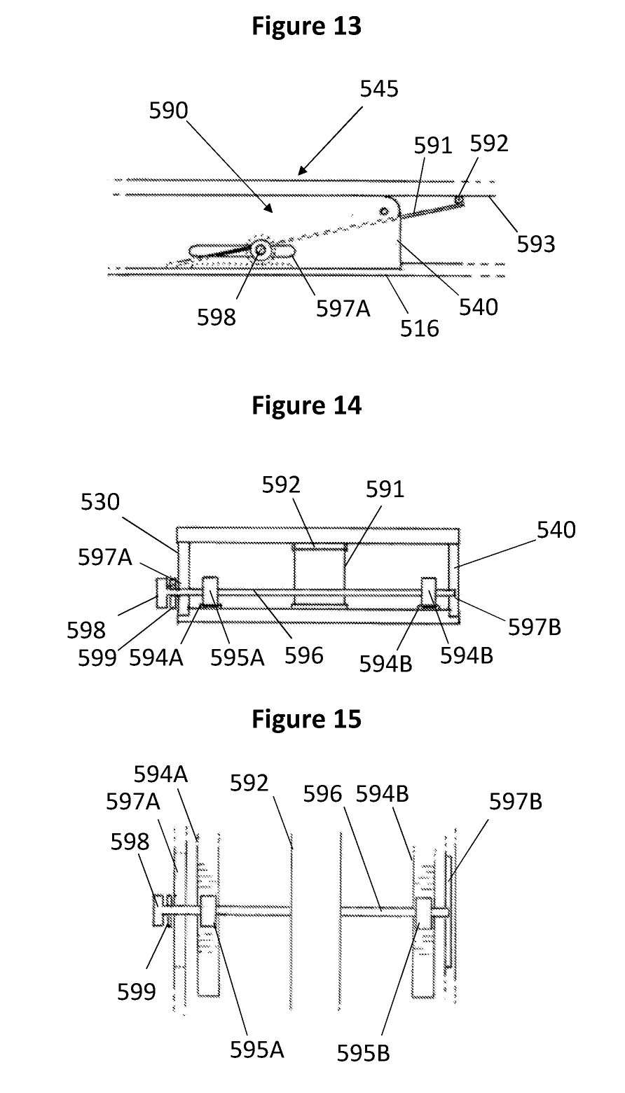

FIG. 13 shows a schematic partial side view of a fifth embodiment of the exerciser according to the invention in a first position;

FIG. 14 shows a schematic end view of the fifth embodiment of the exerciser according to the invention in a first position;

FIG. 15 shows a schematic partial plan view of the fifth embodiment of the exerciser according to the invention in a first position;

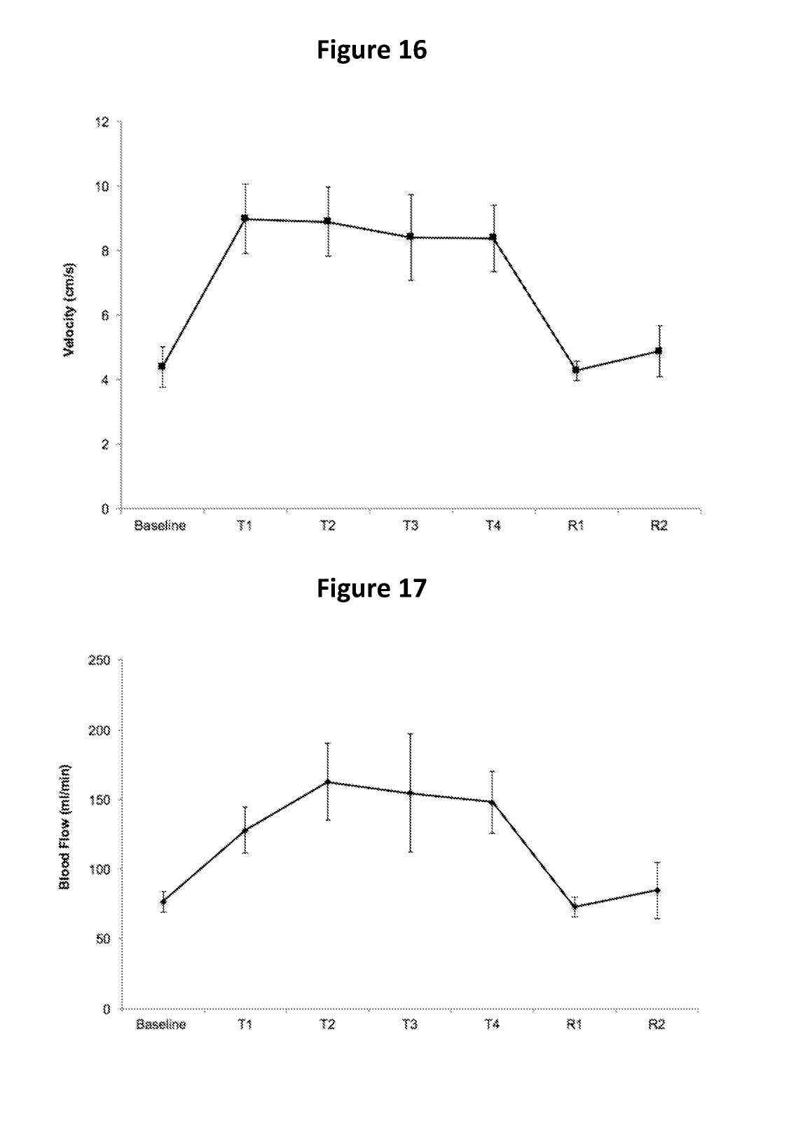

FIG. 16 shows a graph of blood velocity measurements in centimetres per second during a twenty minute test period and a ten minute recovery period where the x-axis shows elapsed time from a baseline measurement to test time periods T1, T2, T3 and T4, and to recovery periods R1 and R2, and where the y-axis shows the blood velocity measurement from 0 cm/s, 2, 4, 6, 8, 10 to 12; and

FIG. 17 shows a graph of blood flow measurements in millilitres per second during a twenty minute test period and a ten minute recovery period where the x-axis shows elapsed time from a baseline measurement to test time periods T1, T2, T3 and T4, and to recovery periods R1 and R2, and where the y-axis shows the blood flow measurement from 0 ml/s, 50, 100, 150, 200 to 250 ml/s.

An exerciser according to a first embodiment of the invention which is illustrated in FIGS. 1 to 4 is indicated generally at 101. Two digit reference numerals for features of the exerciser 101 are prefixed by the numeral “1” to indicate that this is the first embodiment of the invention. Exerciser 101 is suitable for use with one foot. The exerciser 101 comprises a base 110, support 120 and a two-part foot platform 145. The support 120 is mounted on the base 110 and supports the two-part foot platform 145. The exerciser 101 has a proximal end 102 and a distal end 104. In use the heel of the foot of a user of the exerciser is placed at the proximal end 102 of the exerciser 101. The exerciser 101 has a length which should be understood to be between the proximal end 102 and the distal end 104.

Base 110 comprises a rectangular lower fixing plate 112 and a rectangular upper fixing plate 116. Lower fixing plate 112 has four holes 114 formed in it for receiving bolts (not shown). Upper fixing plate 116 has four slots 117, two formations 118 and two proximal grooves 119. Slots 117 are arranged to correspond with the holes 114. Each of slots 117 have a length which runs parallel with the length of the exerciser 101. The slots 117 allow for the exerciser 101 to be arranged in different positions, for example due to variation in the length of the legs of the user. Each groove 119 has a length which is parallel with the length of the exerciser 101 and is provided to each side of the proximal end 102 of the upper fixing plate 116. Formations 118 are provided on each side of the upper fixing plate 116 along approximately two thirds of its length from the proximal end 102 of the exerciser 101, around a shaped part of proximal end 102 of the upper fixing plate 116 and along the length of each groove 119. The upper and lower fixing plates 112,116 allow the exerciser 101 to be bolted to a frame or to a perforated surface (not shown). In an alternate embodiment, base 110 may comprise a single plate 116 without slots 117; such a single plate base 110 may include a connector for mounting the exerciser 101 on a wheelchair. In an alternate embodiment, base 110 may include a connector for mounting the exerciser 101 on a wheelchair, for example to replace a wheelchair footplate. In an alternate embodiment, the slots 117 may be arranged to allow the upper fixing plate 116, support 120 and two-part foot platform 145 to slide forwards and backwards in use relative to the lower fixing plate 114.

Support 120 comprises a left support wall 130 and a right support wall 140. Each support wall 130,140 has an outer wall 132,142 which is approximately two thirds of the length of the upper fixing plate 116, a shaped proximal end 134,144 and an inner wall 136,146 which is the length of grooves 119. Support walls 130,140 have a formation 138,148 along their lower inside edge. Formation 138,148 is shaped to engage with formation 118 of the upper fixing plate 116. Support walls have an axle guide 139,149 at their upper distal corner. In an alternate embodiment, the exerciser 101 has no base 110 and support walls 130,140 are connected by a transverse member. In an alternate embodiment, the support walls 130,140 have a plurality of axle guides 139,149 along the length of the support walls 130,140 such that the exerciser 101 can be adjusted to accommodate different foot sizes.

Two-part foot platform is indicated generally at 145. Two-part foot platform 145 comprises a first lower platform 150 and a second upper platform 160. First lower platform 150 is in the form of a rectangular plate. Extending from its proximal end 102, first lower platform 150 has an indentation 151 in its upper surface which indentation 151 has a floor and is shaped to receive and support the second upper platform 160. Indentation 151 has an opening 152 at its proximal end 102. First lower platform 150 has formations 153 on each of its sides which are shaped to engage with an upper edge of support walls 130,140. First lower platform 150 has shaped ends 154 to each side of opening 152 which are shaped to correspond with shaped proximal ends 134,144 of the support walls 130,140. First lower platform 150 has a first pair of axle guides 155 which are arranged on each side of the first lower platform 150 about two thirds of the length of the first lower platform 150 from its proximal end 102. Axle guides 155 are arranged to be co-axial with axle guides 139,149 of the support walls 130,140 such that when an axle 156 is inserted through the axle guides 139,155,149, a hinge is formed which is indicated generally at 159. In an alternate embodiment, the first lower platform 150 comprises a plurality of pairs of axle guides 155 along its length such that the position of hinge 159 can be adjusted to accommodate different foot sizes.

In use, hinge 159 is generally arranged under or behind the ball of a foot which is the part of the foot between its arch and its toes. In practice, it may be necessary to adjust the position of the hinge 159 by using a different axle guide (not shown) on the support walls 130,140. Hinge 159 allows rotational movement of first lower platform 150 relative to the support walls 130,140. When a foot (not shown) is placed on the exerciser 101, the hinge 159 permits exercising of the foot by plantar flexion movement. Engagement of shaped ends 154 of first lower platform 150 with support walls 130,140 prevents dorsiflexion rotation of first lower platform 150 such that plantar flexion rotational movement is isolated from dorsiflexion rotational movement. Plantar flexion is a movement of a foot which decreases the angle between its sole and the back of its associated leg such that its toes are pushed downwards and dorsiflexion is a movement of a foot where its toes are brought closer to its associated shin such that its heel is pushed downwards. First lower platform 150 has a second pair of axle guides 157 which are arranged on each side of the first lower platform 150 at the distal end of the opening 152, about one third of the length of the first lower platform 160 from its proximal end 102 such that the axle guides are substantially in line with the front of the shin of a user. In an alternate embodiment, the hinge 159 comprises a resilient member to bias the first lower platform 150 to engage with support walls 130,140 such that the resilient member provides resistance to the rotation of hinge 159.

Second upper platform 160 has a substantially oval shape. On its upper surface, second upper platform 160 has a plurality of formations 162 to help secure a foot on the second upper platform 160. At its distal end, second upper platform 160 has a toe cap 164 to help ensure correct positioning of a foot on the second foot platform 160. On its lower surface, second upper platform 160 has a pair of axle guides 166 which are arranged on each side of the upper platform 160 to be co-axial with axle guides 157 of first lower platform 150 such that when an axle 158 is inserted through the axle guides 157,166, a hinge is formed which is indicated generally at 168. Hinge 168 allows rotational movement of second upper platform 160 relative to the first lower platform 150. When a foot is placed on the exerciser 101, the hinge 168 and second upper platform 160 permit exercising of the foot by dorsiflexion movement. Engagement of the distal end of the second upper platform 160 with indentation 151 of the first lower platform 150 prevents plantar flexion rotation of second upper platform 160 such that dorsiflexion rotational movement is isolated from plantar flexion rotational movement. In an alternate embodiment, the hinge 168 comprises a resilient member to bias the second upper platform 160 to engage with indentation 151 of the first lower platform 150 such that the resilient member provides resistance to the rotation of hinge 168.

In an alternate embodiment, the second upper platform 160 includes a monitoring device in the form of an accelerometer to detect rotation of either of the hinges 159,168. This is in order that data can be collected to show frequency and duration of any exercise, and range of movement such that rehabilitation of a patient can be monitored.

In an alternate embodiment, the exerciser may be a dual foot exerciser which comprises two exercisers 101 wherein either the exercisers 101A,101B share a common base 110 or one or both of hinges 159A,159B,168A,168B of each exerciser 101A,101B share a common axle 156,158 such that where a patient has a particular muscle weakness in one leg, the other leg can assist the movement of the weaker leg because the common axle 156,158 means that when one part of the two part foot platform 145A,145B is moved on one exerciser 101A,101B, the corresponding part of the two part foot platform 145B,145A is moved on the other exerciser 101B,101A. In an alternate embodiment, a dual foot exerciser may comprise one or more monitoring devices in one or both of the exercisers 101A,101B. In an alternative embodiment, second platform 160 has an optionally moveable heel cup to help ensure the correct positioning of a foot on the second platform. In an alternative embodiment, the second platform may have a strap for securing a foot to the platform.

An exerciser according to a second embodiment of the invention which is illustrated in FIGS. 5 to 7 is indicated generally at 208. Two digit reference numerals for features of the exerciser 208 are prefixed by the numeral “2” to indicate that this is the second embodiment of the invention. Otherwise like two digit reference numerals are used to indicate like features of the first embodiment of the invention. The exerciser 208 is an exerciser suitable for use with both feet and comprises a left foot exerciser 201A according to the first embodiment of the invention and a right foot exerciser 201B according to the first embodiment of the invention.

Exerciser 208 is adapted to be placed directly on a surface such as the floor. Accordingly left and right foot exercisers 201A,201B each have a base 210A,210B which comprises only an upper plate 216A,216B. Otherwise left and right foot exercisers 201A,201B are substantially the same as the exerciser 101 according to the first embodiment of the invention. In an alternative embodiment, base 210A,210B may comprise a rectangular lower fixing plate 112A,112B and a rectangular upper fixing plate 116A,116B as described for the exerciser 101 according to the first embodiment of the invention. In an alternate embodiment, base 110 may include a connector for mounting the exerciser 208 on a wheelchair, for example to replace a wheelchair footplate.

Exerciser 208 comprises a linking mechanism indicated generally at 270 which links each respective part of the two-part foot platforms 245A,245B of left and right foot exercisers 201A,201B together. Thus each two-part foot platforms 245A,245B has a first lower platform 250A,250B and a second upper platform 260A,260B. First linkage 272 links the first lower platforms 250A,250B together and second linkage 274 links the second upper platforms 260A,260B together. As shown in FIG. 6, as a result of linkage 274 of linking mechanism 270, movement of one lower platform 250A,250B results in movement of the other lower platform 250B,250A. Similarly, as shown in FIG. 7, as a result of linkage 272 of linking mechanism 270, movement of one upper platform 260A,260B results in movement of the other upper platform 2606,260A. As a result of linking mechanism 270, exerciser 208 may enable a stronger leg or a leg having a higher degree of function to assist or teach movement of the other leg.

In an alternate embodiment, linking mechanism 270 comprises linking the hinges 259A,259B for the first lower foot platform 250 and/or hinges 268A,268B for the second upper foot platform either in addition to or instead of first and second linkages 272,274.

An exerciser according to a third embodiment of the invention which is illustrated in FIGS. 8 and 9 is indicated generally at 301. Two digit reference numerals for features of the exerciser 301 are prefixed by the numeral “3” to indicate that this is the third embodiment of the invention. Otherwise like two digit reference numerals are used to indicate like features of the first embodiment of the invention. The exerciser 301 is an exerciser according to the first embodiment of the invention with a reciprocating motor mechanism 380 to assist movement of the second upper platform 360.

Exerciser 301 is adapted to be placed directly on a surface such as the floor. Accordingly exerciser 301 has a base 310 which comprises only an upper plate 316. Reciprocating motor mechanism 380 has a motorised wheel 382, a crank 384 and fitting 386. Reciprocating motor mechanism 380 is mounted on upper plate 316. Fitting 386 is mounted on an underside of second upper platform 360 on the distal side of hinge 368 and crank 384 is rotatably mounted on fitting 386. Crank 384 is also rotatably mounted on motorised wheel 382 such that crank 384 connects upper platform 360 to motorised wheel 382. The reciprocating motor mechanism 380 is arranged to have a first position shown in FIG. 9 where crank 384 is fully retracted and second upper platform 360 is substantially horizontal. Rotation of motorised wheel 382 extends crank 384 upwards such that reciprocating motor mechanism 380 assists a foot placed on second upper platform 360 in a plantar flexion movement until the reciprocating motor mechanism 380 reaches a second position shown in FIG. 8 where crank 384 is fully extended. This operation may be reversed to return the reciprocating motor mechanism 380 to its original position. In an alternative embodiment, exerciser 301 may have a reciprocating motor mechanism 380 mounted on the first lower platform 350 in addition to or instead of the reciprocating motor mechanism 380 mounted on the second upper platform 360. In a further alternate embodiment, the reciprocating motor mechanism may be replaced by an alternative mechanism for assisting movement of one or both parts of the two-part foot platform 345 such as a mechanism using hydraulics, an air-bladder or a solenoid.

In an alternative embodiment, base 310 may comprise a rectangular lower fixing plate 312 and a rectangular upper fixing plate 316 as described for the exerciser 101 according to the first embodiment of the invention. In an alternate embodiment, base 310 may include a connector for mounting the exerciser 301 on a wheelchair, for example to replace a wheelchair footplate. In an alternative embodiment, the exerciser 301 may include a control panel for controlling the speed of rotation of the motor mechanism 380. In an alternative embodiment, the exerciser 301 includes an electrical power supply in the form of a battery or a connection to an external socket, such a connection may include an electrical power transformer.

An exerciser according to a fourth embodiment of the invention which is illustrated in FIGS. 10, 11 and 12 is indicated generally at 401. Two digit reference numerals for features of the exerciser 401 are prefixed by the numeral “4” to indicate that this is the fourth embodiment of the invention. Otherwise like two digit reference numerals are used to indicate like features of the first embodiment of the invention. The exerciser 401 is an exerciser according to the first embodiment of the invention with a twin-cam reciprocating dual motor mechanism 480A,480B to assist movement of the first and second platforms 450,460.

Exerciser 401 is adapted to be placed directly on a surface such as the floor. Accordingly exerciser 401 has a base 410 which comprises only an upper plate 416. Each reciprocating motor mechanism 480A,480B has a respective motorised wheel 482A,482B, a cam 488A,488B, a cam cog 489A,489B, a cam axle 489C,489D, cam axle support 489E, a fitting 486A,486B and a fitting support 486C.

Each reciprocating motor mechanism 480A,480B is mounted on upper plate 416. Fittings 486A,486B are mounted on an underside of platforms 450,460 on the distal side of hinge 468 and cams 488A,488B are arranged to contact fittings 486A,486B. Cams 488A,488B are each rotatably mounted on a respective cam axle 489C,489D on an inner side of motor mechanisms 480A,480B close to the longitudinal central line of the exerciser XX′ as marked on FIG. 12. It is advantageous to have the cams arranged close to the central line XX′ so that the force of the motor mechanisms 480A,480B exerted by the cams 488A,488B is applied to the middle of the platforms 450,460 such that it is applied to the middle of a user's foot and so as to avoid any twisting motion by applying such a force to one side of the foot platforms 450,460.

Each cam 488A,488B has a cam cog 489A,489B. Each cam 488A,488B and cam cog 489A,489B is mounted on its respective cam axle 489C,489D. The cam axles 489C,489D are supported by a fitting (not shown) in each support wall 430,440 and by cam axle support 489E which is arranged on the central line XX′ of the exerciser 401.

Fitting 486B is mounted on an underside of second upper platform 460 and is arranged such that cam 488B engages with fitting 486B. Fitting 486A is mounted on fitting support 486C. Fitting support 486C is attached to first lower platform 450. Fitting support 486C and fitting 486A are arranged such that cam 488A engages with fitting 486A. Fitting support 486C forms a cut out 486D shaped to fit around fitting 486B such that any force exerted by cam 488B on fitting 486B so as to support the motion of the second upper platform 460 does not cause the movement of fitting support 486C such that the first lower platform 450 is moved as well.

The reciprocating motor mechanisms 480A,480B are arranged to have a first position shown in FIG. 11 where cams 488A,488B are fully retracted and the platforms 450,460 are substantially horizontal. Rotation of either motorised wheel 482A,482B causes a supported movement whereby either cam 488A,488B is rotated such that its cam surface (not shown) extends upwards such that either reciprocating motor mechanism 480A,480B assists a foot placed on the platforms 450,460 in a respective movement until the reciprocating motor mechanism 480A,480B reaches a second position (not shown) where the cam surface is fully extended. This operation may be reversed to return the reciprocating motor mechanism 480A,480B to its original position. In an alternative embodiment, exerciser 401 may have a removable cam assembly comprising cam 488A,488B, cam cog 489A,489B and cam axle 489C,489D such that they can be replaced by a different cam assembly having a smaller cam such that the maximum height of the supported movement may be reduced for use with a user with restricted foot mobility. In an alternative embodiment, upper plate 416 may form grooves to align with cams 488A,488B such if pressure is applied to the foot platforms 445, the motor mechanisms 480A,480B may still be operated. The exerciser 401 includes a control panel (not shown) for controlling the speed of rotation of the motor mechanisms 480A,480B. The exerciser 401 includes an electrical power supply in the form of a battery (not shown).

In an alternative embodiment, base 410 may comprise a rectangular lower fixing plate 412 and a rectangular upper fixing plate 416 as described for the exerciser 101 according to the first embodiment of the invention. In an alternate embodiment, base 410 may include a connector for mounting the exerciser 401 on a wheelchair, for example to replace a wheelchair footplate. In a further alternate embodiment, the reciprocating motor mechanisms 480A,480B may be replaced by an alternative mechanism for assisting movement of one or both parts of the two-part foot platform 445 such as a mechanism using hydraulics, an air-bladder or a solenoid. In an alternate embodiment, the exerciser 401 includes an electrical power supply in the form of a connection to an external socket, such a connection may include an electrical power transformer.

An exerciser according to a fifth embodiment of the invention which is illustrated in FIGS. 13, 14 and 15 is indicated generally at 501. Two digit reference numerals for features of the exerciser 401 are prefixed by the numeral “5” to indicate that this is the fifth embodiment of the invention. Otherwise like two digit reference numerals are used to indicate like features of the first embodiment of the invention. The exerciser 501 is an exerciser according to the first embodiment of the invention with a resilient member resistance mechanism 590 to resist movement of the first and/or second platforms 450,460.

Exerciser 501 is adapted to be placed directly on a surface such as the floor. Accordingly exerciser 501 has a base 510 which comprises only an upper plate 516. The resistance mechanism comprises a resilient member 591, a roller pinion 592, a roller pinion track 593, two base tracks 594A,594B, two axle cogs 595A,595B, an axle 596, two slots 597A,597B, a control knob 598 and locking nut 599.

Roller pinion track 593 is mounted on an underside of second upper platform 460. Roller pinion 592 is attached to an upper end of resilient member 591 and is mounted on roller pinion track 593. Resilient member 591 is in the form of a leaf spring. A lower end of resilient member 591 is attached to an upper surface of upper plate 516. Resilient member 591 is arranged to run over axle 596 such that axle 596 forms a pivot for resilient member 591 and changes its resistance. The tension of resilient member 591 may be controlled by controlling the position of axle 596 from distal end 504. The position of axle 596 is controlled by means of axle cogs 595A,595B, base tracks 594A,594B and control knob 598. Axle 596 is constrained to move only horizontally by running through slots 597A,597B formed in side walls 530,540. Axle 596 has axle cogs 595A,594B which are positioned on each side of resilient member 591 proximal to side walls 530,540. Axle cogs 595A,594B are positioned to run on longitudinal base tracks 594A,594B such that the longitudinal position of axle 596 or its distance from distal end 504 may be controlled. Axle 596 has an external thread (not shown) at its left hand end where it extends through left wall 530. Control knob 598 has an internal thread (not shown) for engaging with the external thread of axle 596 such that control knob 598 may be tightened on to axle 596 such that locking nut 599 engages with wall 530 to prevent horizontal movement of axle 596 such that axle 596 may be fixed in position.

In an alternative embodiment, base 510 may comprise a rectangular lower fixing plate 512 and a rectangular upper fixing plate 516 as described for the exerciser 101 according to the first embodiment of the invention. In an alternate embodiment, base 510 may include a connector for mounting the exerciser 501 on a wheelchair, for example to replace a wheelchair footplate. In an alternate embodiment, the resilient member 591 could be in the form of an air bladder or coil spring. In an alternate embodiment, the axle 596 could be part of the resilient member 591.

The exerciser 101 according to the invention was used in a confidential experimental trial to determine its effects on blood velocity and blood flow.

10 healthy and habitually physically active males (18-45 years) with a BMI between 19-29.9 kg/m² were recruited for the study and signed a non-disclosure agreement. Participants were excluded from the study if: i) they smoke; ii) take medication; iii) are obese (BMI 230 kg/m²); iv) have high blood pressure (diastolic >90 and/or systolic blood pressure >140 mmHg); v) and/or have a (history of) cardiovascular, metabolic, haematological, neurological or musculoskeletal (lower limb) disorder.

When participants consented to the trial, they were be provided with a study specific identification number which will be used on all of the study documentation related to the participant. All participants completed a pre-participation health questionnaire. They were informed of the purpose, risks and discomforts associated with investigation, before giving written and informed consent.

Participants were asked to avoid supplements for 72 hours and abstain from exercise, alcohol and caffeine 24h prior to experimental measures. Measures were performed in a quiet, temperature controlled room in the morning after a 10 h overnight fast and at a similar time of day (±1 h).

Individual results were fed back to the participant verbally throughout, and via email following completion of the experimental trial.

### Experimental Design

Participants visited the lab on two occasions for a screening visit and experimental trial. During the experimental trial, the superficial femoral artery blood flow was measured at rest and monitored during 20 min of seated plantar flexion and dorsiflexion exercise (on the exerciser 101), and during 20 min seated recovery. Heart rate and blood pressure were monitored at 5 min intervals during exercise and recovery.

### Screening Visit

Participants attended a screening visit. The study procedures, purpose, risks and benefits were explained to each participant before they provided signed informed consent. All participants completed a pre-participation health questionnaire. Measures of participant height, body mass, resting blood pressure and calf circumference were performed. Body mass index was calculated.

### Experimental Trial

Participants attended the laboratory in the morning (7-8 am) after a 10 h overnight fast, having refrained from exercise for 24 h. Participants rested in a seated position and blood pressure (BP) was measured in the left arm after 5 minutes. The superficial femoral artery was imaged using a duplex ultrasound machine (Acuson Aspen, Siemens, USA) with high resolution linear array-transducer. The ultrasound probe was positioned in the proximal third of the thigh, at least 5 cm distally from the femoral bifurcation into the deep and superficial femoral artery. Resting femoral artery diameter and blood flow was recorded for 20 cardiac cycles following a 20 min seated rest period. Participants then commenced 20 minutes of seated plantar flexion and dorsiflexion exercise on the prototype device (LEEPER, UK) at 30 reps per minute (controlled by a metronome beat), followed by 20 min of seated recovery (no exercise). Femoral artery diameter and blood flow were recorded for 20 cardiac cycles at 5 min intervals throughout the exercise and recovery period. As artery diameter is affected by the contraction and relaxation of the underlying muscle, participants were asked to rest for 30 seconds to allow measurements to be performed. Heart rate and blood pressure were measured at 5 min intervals throughout the exercise and recovery period.

### Analysis

Femoral artery diameter and flow velocity were analysed with a custom-designed, edge detection and wall tracking software (Medical Imaging Applications, Vascular Research Tools 5). Media-to-media diastolic diameter was measured within a specified region of interest on B-mode images. The Doppler flow velocity spectrum was traced and time average mean velocity (TAMV) (cm/s) computed. Synchronized diameter and velocity data, sampled at 20 Hz, enabled calculation of blood flow and shear rate. Diastolic diameters (mm) were averaged over 20 cardiac cycles. Blood flow (ml/min) was calculated as (TAMV×πr2)×60, where r is the radius of the femoral artery lumen, and averaged over 20 cardiac cycles. Shear rate was derived from Poiseuillie's law and calculated accordingly as (4×TAMV)/diameter.

### Statistics

All statistical analysis was performed using SPSS software. A Shapiro-Wilk test was used to confirm normal distribution and a Mauchley test of sphericity to verify homogeneity of variance. A one-way ANOVA with repeated measures was used to evaluate change in femoral artery blood flow over time (rest, exercise [5,10,15, 20 min] and recovery [5, 10, 15, 20 min]) in the experimental trial. Bonferroni corrected post hoc t-tests were used to locate significance. Significance was accepted at P<0.05.

### Results

Femoral artery diameter at baseline was 6.2±0.7 mm and did not change during exercise (average diameter=6.1±0.7 mm) or recovery (average diameter=6.0±0.7 mm) (Repeated Measures ANOVA, P=0.232). This suggests the exercise did not elicit a dilatory response.

There was a significant change in blood velocity over time (Repeated Measures ANOVA, P<0.001). Blood velocity increased after 5 minutes of exercise (Baseline, 4.4±1.4 cm/s vs. T1, 9.0±2.4 cm/s; P=0.007) and remained significantly elevated throughout the 20-minute protocol. Blood velocity decreased to resting values 5 minutes after exercise cessation (T4, 8.4±2.3 cm/s vs. R1, 4.2±0.7 cm/s; P=0.003).

There was a significant change in blood flow over time (Repeated Measures ANOVA, P<0.001). Femoral artery blood flow increased after 5 min of exercise (Baseline, 76.6±17.0 ml/min vs. T1, 128.0±36.4 ml/min; P=0.007) and remained significantly elevated throughout the 20-minute protocol (T2, 162.7±62.3 ml/min; T3, 154.6±95.1 ml/min; T4, 148.0±49.3 ml/min). These blood flow values are higher than that achieved during passive movement of the knee-extensor muscle group, but lower than that observed during a low load knee extension exercise. Blood flow returned to resting values 5 minutes after exercise cessation (T4, 148.0±49.2 ml/min vs. R1, 73.1±15.9 ml/min; P=0.003).

There was a significant change in shear rate over time (Repeated Measures ANOVA, P<0.001). The shear stimulus increased (as a result of increase velocity and unchanged diameter) following 5 min of exercise (Baseline 29.2±11.6 s−1 vs. T1 59.2±14.1 s−1; P=0.007) and remained significantly elevated throughout the 20-minute protocol (T2, 58.1±16.9 s1; T3, 55.2±16.0 s−1; T4, 55.4±16.7 s−1). Shear rate reduced to resting values 5 minutes after exercise cessation (T4, 55.4±16.7 s−1 vs. R1, 28.8±6.0 s−1, P=0.007).

Shear rate is an indirect measure of shear stress; the tangential force exerted by flowing blood, which provides an important tonic drive for endothelial nitric oxide (NO) synthase activation and NO production. Exercise-induced changes in shear are thought to provide the principle stimulus for improved endothelial function and vascular remodelling in response to exercise training.

### REFERENCES

Gillespie, L. D., Gillespie, W. J., Robertson, M. C., Lamb, S. E., Cumming, R. G. & Rowe, B. H. (2003). Interventions for preventing falls in elderly people. Cochrane Database of Systematic Reviews, Issue 4. Sherrington, C., Whitney, J. C., Lord, S. R., Herbert, R. D., Cumming, R. G. & Close, J. C. T. (2008). Effective exercise for the prevention of falls: a systematic review and meta-analysis. Journal of American Geriatric Society, 56: 2234-2243.

1. An exerciser suitable for exercising lower leg muscles wherein the exerciser comprises:
a support; and
a two part foot platform comprising:
a first lower platform connected to the support by a first platform hinge such that the first platform may be rotated relative to the support to allow plantar flexion rotational movement of a foot; and
a second upper platform connected to the first platform by a second platform hinge to allow dorsiflexion rotational movement of the foot.

2. The exerciser of claim 1, which is formed from a sterilisable plastic material, is portable.

3. (canceled)

4. The exerciser of claim 1, which has a connector for a wheelchair.

5. The exerciser of claim 1, which is in the form of a foot rest.

6. The exerciser of claim 1, which comprises a base.

7. The exerciser of claim 6, wherein the base comprises a lower fixing plate and an upper fixing plate which are connectable to allow the base to be attached to a frame or to furniture.

8. The exerciser of claim 1, wherein the support comprises two support walls.

9. The exerciser of claim 1, wherein the support forms a stop to prevent over-rotation of one part of the two part foot platform.

10. (canceled)

11. The exerciser of claim 1, wherein the first platform has an indentation shaped to receive the second platform.

12. The exerciser of claim 11, wherein the indentation has an opening to allow the second platform to be rotated relative to the first platform.

13. The exerciser of claim 1, wherein the first platform is shaped to engage with a support stop.

14. (canceled)

15. The exerciser of claim 1, wherein the first platform hinge comprises a resilient member to provide resistance to the rotation of first platform hinge.

16. The exerciser of claim 1, wherein the second upper platform is shaped to support a foot.

17. The exerciser of claim 1, wherein the second platform has a plurality of formations to help secure a foot.

18. The exerciser of claim 1, wherein the second platform has a toe cap and/or a heel cup to help ensure correct positioning of a foot on the second platform; optionally the heel cup is moveable; optionally the second platform has a strap for securing the foot on the platform.

19. (canceled)

20. (canceled)

21. The exerciser of claim 1, wherein the second platform hinge comprises a resilient member to provide resistance to the rotation of the second platform hinge; optionally the exerciser includes a resilient member resistance mechanism for controlling the degree of resistance provided by the resilient member; optionally the resilient member is a leaf or coil spring or an air bladder.

22. The exerciser of claim 1, wherein the first platform and/or second platform include a monitoring device to detect movement.

23. The exerciser of claim 1, wherein a motor mechanism is connected to the first and/or second parts of the foot platform so as to assist movement of the foot platform; optionally the motor mechanism is positioned to apply force to a middle of each platform; optionally the motor mechanism includes a crank or a cam; optionally the exerciser includes a control panel for controlling the speed of rotation of the motor mechanism; optionally the motor mechanism includes a replaceable linkage such that the degree of movement of the motor mechanism may be varied.

24. A dual foot exerciser which comprises two exercisers of claim 1, wherein the respective first parts of each foot platform are connected together and/or the respective second parts of each foot platform are connected together such that movement of a first or second part on one exerciser moves the corresponding first or second part of the other exerciser.

25. The dual foot exerciser of claim 24, wherein one or both of the hinges of each exerciser share a common axle.
